(19) United States
(12) Patent Application Publication
(10) Pub. No.: US 2018/0342758 A1
(43) Pub. Date: Nov. 29, 2018

(54) SECONDARY BATTERY AND PREPARATION METHOD THEREFOR

(71) Applicant: SHENZHEN INSTITUTES OF ADVANCED TECHNOLOGY, Shenzhen, Guangdong (CN)

(72) Inventors: Yongbing Tang, Shenzhen, Guangdong (CN); Maohua Sheng, Shenzhen, Guangdong (CN); Fan Zhang, Shenzhen, Guangdong (CN); Bifa Ji, Shenzhen, Guangdong (CN)

(21) Appl. No.: 15/777,950

(22) PCT Filed: Apr. 1, 2017
(86) PCT No.: PCT/CN2017/079275

§ 371 Date: May 22, 2018

(30) Foreign Application Priority Data
May 6, 2016 (CN) PCT/CN2016/081346

(51) Int. Cl. H01M 10/0525; H01M 10/0568; H01M 10/0569; H01M 10/0567; H01M 4/525; H01M 4/62; H01M 2/16; H01M 4/58; H01M 4/505; H01M 4/36; H01M 4/66; H01M 10/058

(52) U.S. Cl. CPC H01M 10/0525; H01M 10/058; H01M 10/0569; H01M 10/0567; H01M 4/525; H01M 4/625; H01M 2/1613; H01M 2/1653; H01M 2/1646; H01M 4/5825; H01M 4/505; H01M 4/364; H01M 4/662; H01M 4/667; H01M 10/0568

(57) ABSTRACT

Disclosed are a secondary battery and a preparation method therefor, relating to the field of batteries. The secondary battery comprises a negative electrode, an electrolyte, a separator and a positive electrode, the negative electrode comprises a negative current collector, and the negative current collector also acts as a negative active material; the electrolyte comprises an electrolyte salt and a solvent, and the electrolyte is a lithium salt; the positive electrode comprises a positive current collector and a positive active material layer, and the positive active material layer comprises a positive active material capable of reversibly intercalating and de-intercalating lithium ions.

### TECHNICAL FIELD

The present disclosure relates to the field of batteries, and in particular to a secondary battery and a preparation method therefor.

### BACKGROUND ART

With the development of the level of modern life as well as science and technology, people are consuming and requiring more and more energy, and seeking a new type of energy has become an urgent need today. Lithium ion battery has become a preferred object as a power supply for current electronic products because of its high specific capacity, long cycle life, and high price-quality ratio. Core components of the lithium ion battery generally comprise a positive electrode, a negative electrode, and an electrolyte. A commercial lithium ion battery comprises a transition metal oxide or a polyanionic metal compound as the positive active material, graphite or carbon as the negative active material, and an ester-based electrolyte as the electrolyte. However, when graphite is used as the negative active material, graphite occupies a large part of the volume and weight of the battery, which limits the capacity and energy density of the lithium ion battery, and increases the complexity of the production procedures and the production cost.

### DISCLOSURE OF THE INVENTION

In order to overcome the technical problems described above, the present disclosure provides a secondary battery and a preparation method therefor, and is intended to solve the problem that the existing lithium battery, in which graphite is used as a negative active material, has a low capacity and energy density, is produced by a complex production process, and has a high production cost.

In a first aspect, the present disclosure provides a secondary battery comprising a negative electrode, an electrolyte, a separator, and a positive electrode, wherein

the negative electrode comprises a negative current collector; the negative current collector comprises a metal or a metal alloy or a metal composite conductive material, and the negative current collector also acts as a negative active material;

the electrolyte comprises an electrolyte salt and a solvent, and the electrolyte salt is a lithium salt;

the positive electrode comprises a positive current collector and a positive active material layer, the positive active material layer comprises a positive active material capable of reversibly intercalating and de-intercalating lithium ions, and the positive current collector comprises a metal or a metal alloy or a metal composite conductive material.

Specifically, the positive active material includes one or several of, or a composite material of one of, lithium cobalt oxide, lithium nickel oxide, lithium manganese oxide, lithium iron phosphate, lithium nickel cobalt oxide binary material, spinel-structured lithium manganese, lithium nickel cobalt manganese oxide ternary material, and a layered lithium-rich high manganese material.

Specifically, the negative current collector includes one of aluminum, magnesium, lithium, vanadium, copper, iron, tin, zinc, nickel, titanium, and manganese, or an alloy of any one thereof, or a composite of any one thereof.

Preferably, the negative current collector is aluminum.

Further, the structure of the negative current collector is an aluminum foil, or porous aluminum, or porous aluminum coated with a carbon material, or a multilayered composite material of aluminum.

Specifically, the positive current collector includes one of, or a composite of any one metal of, or an alloy of any one metal of, aluminum, magnesium, lithium, vanadium, copper, iron, tin, zinc, nickel, titanium, and manganese.

Preferably, the positive current collector is aluminum.

Specifically, the electrolyte includes, but is not limited to, one or several of lithium hexafluorophosphate, lithium perchlorate, lithium tetrafluoroborate, lithium acetate, lithium salicylate, lithium acetoacetate, lithium carbonate, lithium trifluoromethanesulfonate, lithium lauryl sulfate, lithium citrate, lithium bis(trimethylsilyl)amide, lithium hexafluoroarsenate, and lithium bis(trifluoromethanesulfonyl)imide, and has a concentration ranging from 0.1 to 10 mol/L. Further, the concentration of the electrolyte salt is 0.5 to 2 mol/L.

Specifically, the solvent includes one or several of ester, sulfone, ether, and nitrile-based organic solvents, or ionic liquids.

Preferably, the solvent includes one or more of propylene carbonate, ethylene carbonate, butylene carbonate, diethyl carbonate, dimethyl carbonate, dipropyl carbonate, ethyl methyl carbonate, methyl propyl carbonate, dibutyl carbonate, butyl methyl carbonate, methyl isopropyl carbonate, methyl ester, methyl formate, methyl acetate, N,N-dimethylacetamide, fluoroethylene carbonate, methyl propionate, ethyl propionate, ethyl acetate, γ-butyrolactone, tetrahydrofuran, 2-methyltetrahydrofuran, 1,3-dioxolane, 4-methyl-1,3-dioxolane, dimethoxymethane, 1,2-dimethoxy ethane, 1,2-dimethoxy propane, triethylene glycol dimethyl ether, dimethyl sulfone, dimethyl ether, ethylene sulfite, propylene sulfite, dimethyl sulfite, diethyl sulfite, and crown ether.

Further, the electrolyte also comprises an additive including one or several of ester, sulfone, ether, nitrile or alkene-based organic additives.

Preferably, the additive includes one or several of fluoroethylene carbonate, vinylene carbonate, vinyl ethylene carbonate, 1,3-propanesultone, 1,4-butanesultone, ethylene sulfate, propylene sulfate, vinylene sulfate, ethylene sulfite, propylene sulfite, dimethylsulfite, diethylsulfite, vinylene sulfite, methyl chloroformate, dimethyl sulfoxide, anisole, acetamide, diazine, pyrimidine, crown ether/12-crown-4, crown ether/18-crown-6, 4-fluoroanisole, fluorinated noncyclic ether, difluoromethyl ethylene carbonate, trifluoromethyl ethylene carbonate, chloroethylene carbonate, bromoethylene carbonate, trifluoromethyl phosphonic acid, bromobutyrolactone, ethyl fluoroacetate, phosphate, phosphite, phosphazene, ethanolamine, carbodiimide, cyclobutyl sulfone, 1,3-dioxolane, acetonitrile, a long-chain alkene, aluminum oxide, magnesium oxide, barium oxide, sodium carbonate, calcium carbonate, carbon dioxide, sulfur dioxide, and lithium carbonate.

Preferably, the additive is vinylene carbonate contained in an amount of 5 wt %.

Preferably, the positive active material layer also comprises a conductive agent and a binder, the content of the positive active material is 60 to 95 wt %, the content of the conductive agent is 0.1 to 30 wt %, and the content of the binder is 0.1 to 10 wt %.

In a second aspect, the present disclosure also provides a method for preparing the secondary battery described above, comprising:

preparing a negative electrode of the battery, wherein a metal or a metal alloy or a metal composite conductive material is cut into a desired size, washed, and then used as a battery negative electrode, the metal or metal alloy or metal composite conductive material acting as both a negative current collector and a negative active material;

preparing an electrolyte, wherein a certain amount of a lithium salt as an electrolyte salt is weighed out, added to a corresponding solvent, and fully stirred and dissolved to provide an electrolyte;

preparing a separator, wherein a porous polymer film, an inorganic porous film or a glass fiber-based film is cut into a desired size and washed clean;

preparing a battery positive electrode, wherein a positive active material, a conductive agent and a binder are weighed out in a certain ratio, added to a suitable solvent and sufficiently grinded into a uniform slurry; a metal or a metal alloy or a metal composite conductive material is taken and used as a positive current collector after its surface is washed; and then the slurry is uniformly applied to the surface of the positive current collector, and after the slurry is completely dried to form a positive active material layer, the positive current collector with the positive active material layer is cut to provide a battery positive electrode with a desired size; and

assembling the battery negative electrode, the electrolyte, the separator, and the battery positive electrode sequentially to provide a secondary battery.

Compared with the prior art, the present disclosure has the following advantageous effects: due to the elimination of the conventional negative active material, the weight, volume and manufacturing cost of the battery are effectively reduced, and the production procedures are simplified; the capacity of the battery is effectively enhanced by using a negative current collector composed of a metal or a metal alloy or a metal composite also as a negative active material simultaneously; with the reduced weight and volume of the battery and the enhanced capacity of the battery, the energy density of the battery is remarkably increased, and the battery has a good charging and discharging cycle performance.

### BRIEF DESCRIPTION OF DRAWINGS

FIG. 1 is a schematic structural diagram of the secondary battery provided in an embodiment of the present disclosure.

### DETAILED DESCRIPTION OF EMBODIMENTS

The present disclosure will be further described in detail below with reference to the accompanying drawing and specific embodiments. The following description is illustrative of a preferred embodiment of the present disclosure. It should be noted that a number of improvements and modifications may be made by those skilled in the art without departing from the principle of the embodiments of the present disclosure, and such improvements and modifications are also considered within the scope of the present disclosure.

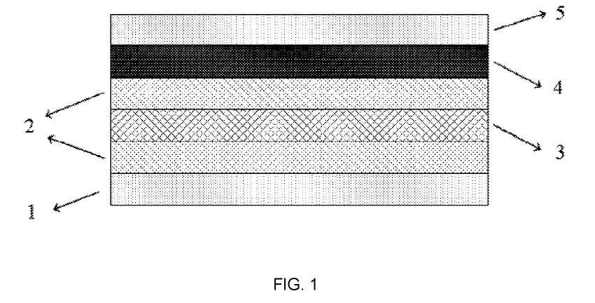

FIG. 1 is a schematic structural diagram of a secondary battery provided in an embodiment of the present disclosure. Referring to FIG. 1, a secondary battery provided in an embodiment of the present disclosure comprises a battery negative electrode 1, an electrolyte 2, a separator 3, a battery positive electrode (comprising a positive active material layer 4 and a positive current collector 5); wherein the battery negative electrode 1 comprises a negative current collector, the negative current collector comprises a metal or a metal alloy or a metal composite conductive material, and the negative current collector also acts as a negative active material; the electrolyte 2 comprises an electrolyte salt and a solvent, and the electrolyte salt is a lithium salt; the battery positive electrode comprises a positive current collector 5 and a positive active material layer 4, the positive current collector comprises metal or metal alloy or metal composite conductive material, and the positive active material layer comprises a positive active material capable of reversibly intercalating and de-intercalating lithium ions.

The working mechanism of the battery provided in the embodiment of the present disclosure is as follows: the secondary battery provided in the embodiment of the present disclosure does not contain a negative active material. During the charging process, lithium ions are de-intercalated from the positive active material and undergoes an alloying reaction with the metal or metal alloy or their composite material which acts as both negative electrode and negative current collector to form a lithium-metal alloy; during the discharging process, the lithium ions are de-intercalated from the lithium-metal alloy on the negative electrode and then intercalated into the positive active material so that the charging and discharging process is achieved. The main difference between the conventional lithium ion battery (i.e., comparative example) and the battery provided in the present application lies in the reactions that occur at the negative electrodes are different, namely, the reaction occurring in the conventional lithium ion battery is an intercalation-de-intercalation reaction of lithium ions, while the negative electrode of the secondary battery of the present disclosure undergoes alloying-dealloying reactions of lithium ions.

The battery provided in the embodiment of the present disclosure does not need conventional negative active material, so that the volume and the cost are reduced; meanwhile, the alloying reaction of the metal with the lithium ions provides a higher battery capacity. The energy density of the battery is remarkably increased by decreasing the weight and volume of the battery and enhancing the battery capacity, and the production cost can be reduced and the production procedures are simplified.

Specifically, in the embodiment of the present disclosure, the positive active material includes, but is not limited to, one or several or a composite material of lithium cobalt oxide (LiCoO₂), lithium nickel oxide (LiNiO₂), lithium manganese oxide (LiMn₂O₄), lithium iron phosphate (LiFePO₄), lithium nickel cobalt oxide binary material (LiNi₁₋ₓCoₓO₂), a spinel structure (LiMn₂₋ₓMₓO₄, M=Ni, Co, Cr or so forth), lithium nickel cobalt manganese oxide ternary material [Li(Ni,Co,Mn)O₂], a layered lithium-rich high manganese material [Li₂MnO₃—Li(NiCoMn)O₂], Li₃M₂(PO₄)₃ (M=V, Fe, Ti, or so forth) of a NASCION (Na Super Ionic Conductor) structure, etc.

Specifically, in the embodiment of the present disclosure, the negative current collector includes, but is not limited to, one of, or an alloy or metal composite of any one of, aluminum, magnesium, lithium, vanadium, copper, iron, tin, zinc, nickel, titanium, and manganese.

Specifically, in the embodiment of the present disclosure, the positive current collector includes, but is not limited to, one of, or an alloy or metal composite of any one of, aluminum, magnesium, lithium, vanadium, copper, iron, tin, zinc, nickel, titanium, and manganese.

Preferably, in the embodiment of the present disclosure, the negative current collector is aluminum.

Preferably, in the embodiment of the present disclosure, the positive current collector is aluminum.

In the present embodiment of the present disclosure, the solvent in the electrolyte is not particularly limited as long as the solvent can dissociate the electrolyte salt into cations and anions, and the cations and anions can freely migrate. For example, the solvent in the embodiment of the present disclosure is an ester, sulfone, ether, or nitrile-based organic solvent or ionic liquid. The solvent includes, but is not limited to, one or more of propylene carbonate, ethylene carbonate, butylene carbonate, diethyl carbonate, dimethyl carbonate, dipropyl carbonate, ethyl methyl carbonate, methyl propyl carbonate, dibutyl carbonate, butyl methyl carbonate, methyl isopropyl carbonate, methyl ester, methyl formate, methyl acetate, N,N-dimethylacetamide, fluoroethylene carbonate, methyl propionate, ethyl propionate, ethyl acetate, γ-butyrolactone, tetrahydrofuran, 2-methyltetrahydrofuran, 1,3-dioxolane, 4-methyl-1,3-dioxolane, dimethoxymethane, 1,2-dimethoxy ethane, 1,2-dimethoxy propane, triethylene glycol dimethyl ether, dimethyl sulfone, dimethyl ether, ethylene sulfite, propylene sulfite, dimethyl sulfite, diethyl sulfite, and crown ether.

Further, in order to prevent damage of the negative current collector caused by the volume change during charging and discharging so that the structure and function of the negative current collector are stabilized and the service life and performance of the negative current collector are improved so as to improve the cycle efficiency of the secondary battery, the electrolyte in the embodiment of the present disclosure also comprises an additive, including, but not limited to, one or several of fluoroethylene carbonate, vinylene carbonate, vinyl ethylene carbonate, 1,3-propanesultone, 1,4-butanesultone, ethylene sulfate, propylene sulfate, vinylene sulfate, ethylene sulfite, propylene sulfite, dimethylsulfite, diethylsulfite, vinylene sulfite, methyl chloroformate, dimethyl sulfoxide, anisole, acetamide, diazine, pyrimidine, crown ether/12-crown-4, crown ether/18-crown-6, 4-fluoroanisole, fluorinated noncyclic ether, difluoromethyl ethylene carbonate, trifluoromethyl ethylene carbonate, chloroethylene carbonate, bromoethylene carbonate, trifluoromethyl phosphonic acid, bromobutyrolactone, ethyl fluoroacetate, phosphate, phosphite, phosphazene, ethanolamine, carbodiimide, cyclobutyl sulfone, 1,3-dioxolane, acetonitrile, a long-chain alkene, aluminum oxide, magnesium oxide, barium oxide, sodium carbonate, calcium carbonate, carbon dioxide, sulfur dioxide, and lithium carbonate. Moreover, the content of the additive is from 0.1 to 20 wt %, and further from 1 to 5 wt %. The additive added in the electrolyte can form a stable solid electrolyte salt membrane on the surface of the negative current collector, so that the negative current collector is not damaged when reacting as an active material and can maintain its function and shape and increase the number of times of cycles of the battery.

Preferably, the additive is vinylene carbonate in an amount of 5 wt %.

Further, the positive active material layer also comprises a conductive agent and a binder, the content of the positive active material is 60 to 95 wt %, the content of the conductive agent is 0.1 to 30 wt %, and the content of the binder is 0.1 to 10 wt %. Moreover, the conductive agent and the binder are not particularly limited, and those commonly used in the art are applicable. The conductive agent is one or more of conductive carbon black, Super P conductive carbon spheres, conductive graphite KS6, carbon nanotube, conductive carbon fiber, graphene, and reduced graphene oxide. The binder is one or more of polyvinylidene fluoride, polytetrafluoroethylene, polyvinyl alcohol, carboxymethyl cellulose, SBR rubber, and polyolefins.

Further, more preferably, the negative current collector is aluminum foil, or porous aluminum, or porous aluminum coated with carbon material, or a multilayered composite material of aluminum. The use of the porous aluminum foil results in a more sufficient alloying reaction between the lithium ions de-intercalated from the positive active material with the aluminum metal to enhance the capacity of the battery; the use of the porous aluminum structure coated with carbon material is advantageous to maintaining the structural stability of aluminum due to the protection effect of the coated carbon layer to further improve the cycle stability of the battery, while enhancing the capacity of the battery; and the use of the multilayered composite material of aluminum is also advantageous to the inhibition and amelioration of the volume expansion effect of the aluminum foil to improve the cycle performance of the battery.

Specifically, the component of the separator used in the secondary battery provided in the embodiment of the present disclosure is an insulating, porous polymer film or inorganic porous film, including one or more of a porous polypropylene film, a porous polyethylene film, a porous composite polymer film, a glass fiber-based film, or a porous ceramic separator. The function of the separator is to physically insulate the positive and negative electrodes of the battery to prevent short circuit while allowing ions in the electrolyte to pass freely there through.

In a second aspect, an embodiment of the present disclosure also provides a method for preparing the secondary battery described above, comprising:

Step 101 of preparing a battery negative electrode, wherein a metal or a metal alloy or a metal composite conductive material is cut into a desired size, then a surface of the cut metal conductive material is washed, the washed metal conductive material is used as a negative current collector, and the negative current collector is used as the battery negative electrode;

Step 102 of preparing an electrolyte, wherein a certain amount of electrolyte salt is weighed out, added to a corresponding solvent, and fully stirred and dissolved;

Step 103 of preparing a separator, wherein a porous polymer film, an inorganic porous film or a glass fiber-based film is cut into a desired size and washed clean;

Step 104 of preparing a battery positive electrode, wherein a positive active material, a conductive agent and a binder are weighed out in a certain ratio, added to a suitable solvent and sufficiently grinded into a uniform slurry to form a positive active material layer; a metal or a metal alloy or a metal composite conductive material is used as a positive current collector with its surface washed; and then the positive active material positive active material layer is uniformly applied to the surface of the positive current collector, and after the positive active material layer is completely dried, the positive current collector with the positive active material layer is cut to provide the battery positive electrode with a desired size;

Step 105 of assembling with the battery negative electrode, the electrolyte, the separator, and the battery positive electrode.

Specifically, in the embodiment of the present disclosure, the metal conductive material in the Step 101 is one of aluminum, magnesium, lithium, vanadium, copper, iron, tin, zinc, nickel, titanium, and manganese, or an alloy of any one thereof, or a composite of any one thereof.

In the embodiment of the present disclosure, the electrolyte salt in the Step 102 is a lithium salt, and the solvent includes an ester, sulfone, ether, or nitrile-based organic solvent. The preparation of the electrolyte also comprises: adding an additive to the solvent and stirring the same. Preferably, the solvent includes, but is not limited to, one or more of ethylene carbonate, diethyl carbonate, dimethyl carbonate, and ethyl methyl carbonate; the additive is one or several of vinylene carbonate, ethylene sulfite, propylene sulfite, ethylene sulfate, cyclobutyl sulfone, 1,3-dioxolane, acetonitrile, or a long-chain alkene.

Preferably, in the embodiment of the present disclosure, the positive active material in the Step 104 is selected from one or several of lithium cobalt oxide, lithium manganese oxide, lithium titanate, lithium nickel cobalt manganese oxide, or lithium iron phosphate. The metal conductive material includes, but is not limited to, one of aluminum, magnesium, lithium, vanadium, copper, iron, tin, zinc, nickel, titanium, and manganese, or an alloy of any one thereof, or a composite of any one thereof.

Preferably, in the embodiment of the present disclosure, the Step 105 of assembling with the battery negative electrode, the electrolyte, the separator, and the battery positive electrode specifically comprises: stacking the prepared negative electrode, separator, and battery positive electrode closely successively under an inert gas or anhydrous and anaerobic condition, adding the electrolyte to completely impregnate the separator, and then packaging them into a battery case to complete the assembly of the battery.

It should be noted that although the operations of the preparation method of the present disclosure have been described in the above steps 101-104 in a specific order, this does not require or imply that these operations must be performed in the specific order. The preparations in the steps 101-104 can be performed simultaneously or in any sequence.

The method for preparing a secondary battery is based on the same inventive concept with the secondary battery described previously, and a secondary battery obtained by the method for preparing a secondary battery has all the effects of the secondary battery described previously and therefore will not be described in detail here.

The above-mentioned method for preparing a secondary battery will be further described below by way of specific examples. However, it should be understood that these examples are only used for a more detailed description, and should not be construed as limiting the present disclosure in any way.

### Example 1

Preparation of negative electrode of a battery: an aluminum foil with a thickness of 0.02 mm was taken, cut into a disc with a diameter of 12 mm, washed with ethyl alcohol, and dried by airing so as to be used as a negative current collector.

Preparation of a separator: a glass fiber paper was cut into a disc with a diameter of 16 mm, and dried by baking so as to be used as a separator.

Preparation of an electrolyte: 1.5 g of lithium hexafluorophosphate (at a concentration of 1 mol/L) was weighed out and added to a mixed solvent composed of 3.2 mL of ethylene carbonate, 3.2 mL of dimethyl carbonate and 3.2 mL of ethyl methyl carbonate, to which 5% by weight of vinylene carbonate (0.545 g) was added as an additive, and was stirred sufficiently until the lithium hexafluorophosphate was completely dissolved so as to be used as an electrolyte.

Preparation of positive electrode of a battery: 0.4 g of lithium cobalt oxide, 0.05 g of carbon black, and 0.05 g of polyvinylidene fluoride were added to 2 mL of a N-methylpyrrolidone solution, and grinded sufficiently to provide a uniform slurry; and then the slurry was uniformly applied to the surface of an aluminum foil and dried in vacuum. The dried electrode sheet was cut into a disc with a diameter of 10 mm, and compacted so as to be used as a positive electrode.

The assembly of a battery: in a glove box under the protection of inert gas, the above prepared negative current collector, separator and battery positive electrode were stacked closely in this order, to which the electrolyte was added dropwise to completely impregnate the separator, and then the above stacked parts were packaged in a button battery case to complete the assembly of the battery.

### COMPARATIVE EXAMPLE

Preparation of negative electrode of a battery: 0.4 g of graphite, 0.05 g of carbon black, and 0.05 g of polyvinylidene fluoride were added to 2 mL of a N-methylpyrrolidone solution, and grinded sufficiently to provide a uniform slurry; and then the slurry was uniformly applied to the surface of an aluminum foil and dried in vacuum. The dried electrode sheet was cut into a disc with a diameter of 10 mm, and compacted so as to be used as a negative electrode.

Preparation of a separator: polymeric polyethylene was cut into a disc with a diameter of 16 mm, and dried by baking so as to be used as a separator.

Preparation of an electrolyte: 0.75 g of lithium hexafluorophosphate was weighed out and added to 2.5 mL of ethylene carbonate and 2.5 mL of dimethyl carbonate, and was stirred sufficiently until the lithium hexafluorophosphate was completely dissolved so as to be used as an electrolyte.

Preparation of positive electrode of a battery: 0.4 g of lithium cobalt oxide as a positive electrode material, 0.05 g of carbon black, and 0.05 g of polyvinylidene fluoride were added to 2 mL of a N-methylpyrrolidone solution, and grinded sufficiently to provide a uniform slurry; and then the slurry was uniformly applied to the surface of an aluminum foil and dried in vacuum. The dried electrode sheet was cut into a disc with a diameter of 10 mm, and compacted so as to be used as a battery positive electrode.

The assembly of a battery: in a glove box under the protection of inert gas, the above prepared negative current collector, separator and battery positive electrode were stacked closely successively, to which the electrolyte was added dropwise to completely impregnate the separator, and then the above stacked parts were packaged in a button battery case to complete the assembly of the battery.

Battery Performance Testing

Charging-discharging Test: the secondary battery prepared in the embodiment of the above method for preparing a secondary battery was charged with a constant current of 100 mA/g of the positive active material until its voltage reached 4.2 V, and then discharged at the same current until its voltage reached 3 V, its battery capacity and energy density were measured, and its cycle stability was tested and expressed by the number of cycles, which refers to the number of times of charges and discharges of the battery when the battery capacity decays to 85%.

The electrochemical performance of the secondary battery provided in Example 1 of the present disclosure was tested, and compared with the performance of the conventional lithium ion battery mentioned in the Background Art, and the results and comparison were shown in Table 1.

TABLE 1
Comparison of Electrochemical Performance Parameters of Example 1 and the Conventional Lithium Ion Battery in the Background Art

| | Posi- | Posi- | Nega- | Nega- | | | | Electrochemical | | | |
|---|---|---|---|---|---|---|---|---|---|---|---|
| | tive | tive | tive | tive | | | | Performance | | | |
| | current | active | current | active | Electrolyte | | | Working | Energy | | |
| | collec- | mate- | collec- | mate- | Electrolyte | | Concen- | Voltage | Density | | Working |
| No. | tor | rial | tor | rial | salt | Solvent | tration | (V) | (Wh/kg) | Cost | Mechanism |
| Example 1 | Al foil | lithium | Al foil (acting as both | | LiPF₆ | ethylene carbonate + | 1M | 3.6 V | 263 | low | Negative |
| | | cobalt | the current collector | | | dimethyl | | | | | electrode:Al + |
| | | oxide | and the negative | | | carbonate + | | | | | Li⁺ + e⁻↔AlLi; |
| | | | active material) | | | ethyl methyl | | | | | Positive |
| | | | | | | carbonate | | | | | electrode:LiCoO₂ ↔ |
| | | | | | | (1:1:1) + 5% | | | | | Li₁₋ₓCoO₂ + |
| | | | | | | vinylene | | | | | xLi⁺ + xe⁻ |
| | | | | | | carbonate as an | | | | | |
| | | | | | | additive | | | | | |
| conven- | Al foil | lithium | Al foil | graphite | LiPF₆ | ethylene | 1M | 3.7 V | 170 | high | Negative |
| tional | | con- | | | | carbonate:ethyl | | | | | electrode:6C + |
| lithium | | taining | | | | methyl | | | | | Li⁺ + e⁻ [symbol] LiC₆; |
| ion battery | | com- | | | | carbonate:dimethyl | | | | | Positive |
| | | pound | | | | carbonate = 1:1:1 | | | | | electrode:LiCoO₂ [symbol] |
| | | | | | | | | | | | Li₁₋ₓCoO₂ + Li⁺ + e⁻ |

As can be seen from Table 1, the secondary battery of Example 1 of the present disclosure contains no graphite in the negative electrode, has reduced raw material cost and process cost, and has a further increased energy density, as compared with the conventional lithium ion battery.

### Examples 2-18

Examples 2-18 are the same as Example 1 in the steps of the process for preparing a secondary battery, except that the material selected for the negative current collector is different. See Table 2 for details.

TABLE 2
Comparison of Performance of Batteries with
Different Negative Current Collectors

| | | Electrochemical Performance | | |
|---|---|---|---|---|
| | | | Number of times | |
| | | Specific | of cycles (times) | Energy |
| | Negative current | Capacity | when the capacity | Density |
| No. | collector | (mAh/g) | decays to 90% | (Wh/kg) |
| Example 1 | aluminum foil | 170 | 250 | 263 |
| Example 2 | magnesium foil | 150 | 30 | 232 |
| Example 3 | lithium foil | 170 | 250 | 263 |
| Example 4 | vanadium foil | 140 | 50 | 217 |
| Example 5 | copper foil | 120 | 100 | 186 |
| Example 6 | iron foil | 120 | 100 | 186 |
| Example 7 | tin foil | 150 | 150 | 232 |
| Example 8 | zinc foil | 170 | 200 | 263 |
| Example 9 | nickel foil | 140 | 150 | 217 |
| Example 10 | titanium foil | 150 | 200 | 232 |
| Example 11 | manganese foil | 120 | 150 | 186 |
| Example 12 | aluminum-tin | 170 | 220 | 263 |
| | alloy | | | |
| Example 13 | aluminum- | 170 | 220 | 263 |
| | titanium alloy | | | |
| Example 14 | iron-tin alloy | 140 | 180 | 217 |
| Example 15 | porous aluminum | 170 | 150 | 263 |
| Example 16 | porous aluminum | 170 | 500 | 263 |
| | @ C | | | |
| Example 17 | porous aluminum | 170 | 500 | 263 |
| | @ graphene | | | |
| Example 18 | multilayered | 170 | 500 | 263 |
| | aluminum com- | | | |
| | posite material | | | |

As can be seen from Table 2, when aluminum foil and the related composite materials thereof are selected as the negative current collector, the battery has a higher specific capacity, better cycle performance, higher energy density, and lower cost.

### Examples 19-29

Examples 19-29 are the same as Example 1 in the steps of the process for preparing a secondary battery, except that the material selected for the positive active material is different. See Table 3 for details.

TABLE 3
Comparison of Performance of Batteries with Different Positive Active Materials

| | | Electrochemical Performance | | |
|---|---|---|---|---|
| | | | Number of times | |
| | | Specific | of cycles (times) | Energy |
| | | Capacity | when the capacity | Density |
| No. | Positive active material | (mAh/g) | decays to 90% | (Wh/kg) |
| Example 1 | lithium cobalt oxide | 170 | 250 | 263 |
| Example 19 | lithium nickel oxide | 150 | 250 | 232 |
| Example 20 | layered lithium manganese oxide | 120 | 250 | 186 |
| Example 21 | lithium iron phosphate | 120 | 500 | 186 |
| Example 22 | Spinel-type lithium manganese oxide | 100 | 200 | 155 |
| Example 23 | lithium nickel cobalt oxide binary material | 150 | 250 | 232 |
| Example 24 | lithium nickel cobalt manganese oxide ternary | 170 | 250 | 263 |
| | material | | | |
| Example 25 | layered lithium-rich high manganese material | 250 | 250 | 387 |
| Example 26 | lithium cobalt oxide + lithium iron phosphate | 150 | 300 | 232 |
| Example 27 | lithium manganese oxide + lithium nickel cobalt | 150 | 250 | 232 |
| | manganese oxide ternary material | | | |
| Example 28 | lithium cobalt oxide @ graphene | 170 | 400 | 263 |
| Example 29 | lithium iron phosphate @ C | 120 | 700 | 186 |

### Examples 30-45

Examples 30-45 are the same as Example 1 in the steps of the process for preparing a secondary battery, except that the electrolyte salt is different. See Table 4 for details.

TABLE 4
Comparison of Performance of Batteries with Different Electrolyte Salts

| | | Electrochemical Performance | | |
|---|---|---|---|---|
| | | | Number of times | |
| | | Specific | of cycles (times) | Energy |
| | | Capacity | when the capacity | Density |
| No. | Electrolyte Salt | (mAh/g) | decays to 90% | (Wh/kg) |
| Example 1 | lithium hexafluorophosphate | 170 | 250 | 263 |
| Example 30 | lithium perchlorate | 160 | 240 | 248 |
| Example 31 | lithium acetate | 100 | 150 | 155 |
| Example 32 | lithium tetrafluoroborate | 150 | 220 | 232 |
| Example 33 | lithium salicylate | 100 | 100 | 155 |
| Example 34 | lithium acetoacetate | 80 | 120 | 124 |
| Example 35 | lithium carbonate | 80 | 120 | 124 |
| Example 36 | lithium trifluoromethanesulfonate | 120 | 150 | 186 |
| Example 37 | lithium citrate | 80 | 150 | 124 |
| Example 38 | lithium lauryl sulfate | 130 | 180 | 201 |
| Example 39 | lithium bis(trimethylsilyl)amide | 150 | 180 | 232 |
| Example 40 | lithium hexafluoroarsenate | 140 | 200 | 217 |
| Example 41 | lithium bis(trifluoromethanesulfonyl)imide | 160 | 150 | 248 |
| Example 42 | lithium hexafluorophosphate + lithium carbonate | 160 | 300 | 248 |
| Example 43 | lithium tetrafluoroborate + lithium citrate | 140 | 180 | 217 |
| Example 44 | lithium trifluoromethanesulfonate + lithium | 140 | 250 | 217 |
| | bis(trimethylsilyl)amide | | | |
| Example 45 | lithium hexafluorophosphate + lithium | 140 | 200 | 217 |
| | perchlorate + lithium tetrafluoroborate | | | |

As can be seen from Table 4, when the electrolyte salt is LiPF₆, the battery has higher specific capacity, better cycle stability, and higher energy density.

### Example 46-50

Examples 46-50 are the same as Example 1 in the steps of the process for preparing a secondary battery, except that the concentration of the electrolyte salt is different. See Table 5 for details.

TABLE 5
Comparison of Performance of Batteries with
Different Electrolyte Salt Concentrations

| | | Electrochemical Performance | | |
|---|---|---|---|---|
| | | | Number of times | |
| | Electrolyte | Specific | of cycles (times) | Energy |
| | Salt | Capacity | when the capacity | Density |
| No. | Concentration | (mAh/g) | decays to 90% | (Wn/kg) |
| Example 46 | 0.1M | 120 | 250 | 186 |
| Example 47 | 0.5M | 140 | 250 | 217 |
| Example 1 | 1M | 170 | 250 | 263 |
| Example 48 | 2M | 170 | 180 | 263 |
| Example 49 | 3M | 170 | 100 | 263 |
| Example 50 | 4M | 170 | 50 | 263 |

As can be seen from Table 5, when the concentration of the electrolyte salt is 1 M (mol/L), the specific capacity, energy density and cycle performance of the battery are all higher.

### Examples 51-94

Examples 51-94 are the same as Example 1 in the steps of the process for preparing a secondary battery, except that the type of the solvent in the electrolyte is different. See Table 6 for details.

TABLE 6
Comparison of Performance of Batteries with
Different Solvents in the Electrolytes

| | | Electrochemical Performance | |
|---|---|---|---|
| | | Number of times | |
| | | of cycles (times) | Energy |
| | | when the capacity | Density |
| No. | Solvent of the electrolyte | decays to 90% | (Wh/kg) |
| Example 51 | propylene carbonate | 100 | 100 |
| Example 52 | ethylene carbonate | 50 | 60 |
| Example 53 | diethyl carbonate | 150 | 140 |
| Example 54 | dimethyl carbonate | 150 | 140 |
| Example 55 | ethyl methyl carbonate | 150 | 140 |
| Example 56 | methyl formate | 100 | 60 |
| Example 57 | methyl acetate | 100 | 80 |
| Example 58 | N,N-dimethylacetamide | 120 | 50 |
| | (DMA) | | |
| Example 59 | fluoroethylene carbonate | 150 | 120 |
| | (FEC) | | |
| Example 60 | methyl propionate (MP) | 100 | 80 |
| Example 61 | ethyl propionate (EP) | 100 | 80 |
| Example 62 | ethyl acetate (EA) | 100 | 80 |
| Example 63 | γ-butyrolactone (GBL) | 80 | 60 |
| Example 64 | tetrahydrofuran (THF) | 50 | 120 |
| Example 65 | triethylene glycol dimethyl | 80 | 140 |
| | ether (DG) | | |
| Example 66 | propylene sulfite (PS) | 100 | 160 |
| Example 67 | dimethyl sulfone (MSM) | 80 | 150 |
| Example 68 | dimethyl ether (DME) | 50 | 100 |
| Example 69 | ethylene sulfite (ES) | 60 | 160 |
| Example 70 | dipropyl carbonate | 150 | 140 |
| Example 71 | butylene carbonate | 150 | 140 |
| Example 72 | methyl propyl carbonate | 180 | 140 |
| Example 73 | dibutyl carbonate | 180 | 140 |
| Example 74 | methyl butyl carbonate | 160 | 140 |
| Example 75 | methyl isopropyl carbonate | 120 | 120 |
| Example 76 | methyl ester | 80 | 100 |
| Example 77 | 2-methyltetrahydrofuran | 60 | 80 |
| Example 78 | 1,3-dioxolane | 60 | 60 |
| Example 79 | 4-methyl-1,3-dioxolane | 50 | 60 |
| Example 80 | dimethoxymethane | 50 | 80 |
| Example 81 | 1,2-dimethoxypropane | 80 | 80 |
| Example 82 | dimethyl sulfite | 120 | 140 |
| Example 83 | diethyl sulfite | 120 | 140 |
| Example 84 | crown ether | 80 | 80 |
| Example 85 | dimethoxymethane + | 50 | 80 |
| | 1,2-dimethoxypropane | | |
| | (v/v 1:1) | | |
| Example 86 | methyl isopropyl car- | 100 | 140 |
| | bonate + methyl butyl | | |
| | carbonate (v/v 1:1) | | |
| Example 87 | ethylene carbonate + | 180 | 200 |
| | propylene carbonate | | |
| | (v/v 1:1) | | |
| Example 88 | ethylene carbonate + | 200 | 240 |
| | ethyl methyl carbonate | | |
| | (v/v 1:1) | | |
| Example 89 | ethylene carbonate + | 200 | 240 |
| | dimethyl carbonate | | |
| | (v/v 1:1) | | |
| Example 90 | ethylene carbonate + | 160 | 180 |
| | dimethyl ether (v/v 1:1) | | |
| Example 91 | ethylene carbonate + | 150 | 180 |
| | dimethylsulfoxide (v/v 1:1) | | |
| Example 92 | triethylene glycol dimethyl | 100 | 80 |
| | ether + sulfolane (v/v 1:1) | | |
| Example 93 | ethylene carbonate + | 220 | 240 |
| | ethyl methyl carbonate + | | |
| | propylene carbonate | | |
| | (v/v/v 1:1:1) | | |
| Example 94 | ethyl methyl carbonate + | 150 | 180 |
| | tetrahydrofuran + di- | | |
| | methoxymethane + 1,2- | | |
| | dimethoxypropane | | |
| | (v/v/v 1:1:1) | | |
| Example 1 | ethylene carbonate + | 250 | 263 |
| | ethyl methyl carbonate + | | |
| | dimethyl carbonate | | |
| | (v/v/v 1:1:1) | | |

### Examples 95-145

Examples 95-145 are the same as Example 1 in the steps of the process for preparing a secondary battery, except that the type of the additive in the electrolyte is different. See Table 7 for details.

TABLE 7
Comparison of Performance of Batteries with Different Additives in the Electrolytes

| | | Electrochemical Performance | |
|---|---|---|---|
| | | Number of times | |
| | | of cycles (times) | Energy |
| | | when the capacity | Density |
| No. | Additive in the Electrolyte | decays to 90% | (Wh/kg) |
| Example 1 | vinylene carbonate (5 wt %) | 250 | 263 |
| Example 95 | vinylene sulfite (5 wt %) | 220 | 263 |
| Example 96 | propylene sulfite (5 wt %) | 200 | 256 |
| Example 97 | ethylene sulfate (5 wt %) | 220 | 240 |
| Example 98 | ethylene sulfite (5 wt %) | 230 | 240 |
| Example 99 | acetonitrile (5 wt %) | 200 | 240 |
| Example 100 | long-chain alkene (5 wt %) | 180 | 240 |
| Example 101 | vinyl ethylene carbonate (5 wt %) | 220 | 240 |
| Example 102 | 1,3-propanesultone (5 wt %) | 160 | 240 |
| Example 103 | 1,4-butanesultone (5 wt %) | 160 | 245 |
| Example 104 | propylene sulfate (5 wt %) | 220 | 256 |
| Example 105 | 1,3-dioxolane (5 wt %) | 160 | 213 |
| Example 106 | dimethylsulfite (5 wt %) | 200 | 240 |
| Example 107 | diethylsulfite (5 wt %) | 200 | 240 |
| Example 108 | methyl chloroformate (5 wt %) | 180 | 235 |
| Example 109 | dimethyl sulfoxide (5 wt %) | 180 | 230 |
| Example 110 | anisole (5 wt %) | 160 | 230 |
| Example 111 | acetamide (5 wt %) | 160 | 230 |
| Example 112 | diazine (5 wt %) | 140 | 205 |
| Example 113 | pyrimidine (5 wt %) | 140 | 230 |
| Example 114 | crown ether/12-crown-4 (5 wt %) | 140 | 220 |
| Example 115 | crown ether/18-crown-6 (5 wt %) | 140 | 220 |
| Example 116 | 4-fluoroanisole (5 wt %) | 160 | 260 |
| Example 117 | fluorinated noncyclic ether (5 wt %) | 140 | 230 |
| Example 118 | difluoromethyl ethylene carbonate (5 wt %) | 140 | 230 |
| Example 119 | trifluoromethyl ethylene carbonate (5 wt %) | 140 | 240 |
| Example 120 | chloroethylene carbonate (5 wt %) | 140 | 240 |
| Example 121 | bromoethylene carbonate (5 wt %) | 140 | 240 |
| Example 122 | trifluoromethyl phosphonic acid (5 wt %) | 150 | 240 |
| Example 123 | bromobutyrolactone (5 wt %) | 150 | 230 |
| Example 124 | fluoroacetoxyethane (5 wt %) | 180 | 230 |
| Example 125 | phosphate (5 wt %) | 150 | 220 |
| Example 126 | phosphite (5 wt %) | 150 | 220 |
| Example 127 | phosphazene (5 wt %) | 200 | 220 |
| Example 128 | ethanolamine (5 wt %) | 200 | 230 |
| Example 129 | carbodiimide (5wt %) | 180 | 225 |
| Example 130 | cyclobutyl sulfone (5 wt %) | 220 | 230 |
| Example 131 | aluminum oxide (5 wt %) | 200 | 240 |
| Example 132 | magnesium oxide (5 wt %) | 200 | 240 |
| Example 133 | barium oxide (5 wt %) | 200 | 240 |
| Example 134 | sodium carbonate (5 wt %) | 200 | 240 |
| Example 135 | calcium carbonate (5 wt %) | 200 | 256 |
| Example 136 | carbon dioxide (5 wt %) | 180 | 255 |
| Example 137 | sulfur dioxide (5 wt %) | 180 | 253 |
| Example 138 | lithium carbonate (5 wt %) | 240 | 253 |
| Example 139 | fluoroethylene carbonate (5 wt %) | 120 | 260 |
| Example 140 | vinylene carbonate (2.5 wt %) + | 160 | 260 |
| | vinylene sulfite (2.5 wt %) | | |
| Example 141 | ethanolamine (2.5 wt %) + vinyl | 150 | 240 |
| | ethylene carbonate (2.5 wt %) | | |
| Example 142 | dimethylsulfoxide (2.5 wt %) + | 150 | 225 |
| | diazine (2.5 wt %) | | |
| Example 143 | propylene sulfite (2.5 wt %) + | 180 | 240 |
| | aluminum oxide (2.5 wt %) | | |
| Example 144 | lithium carbonate (2.5 wt %) + | 220 | 256 |
| | barium carbonate (2.5 wt %) | | |

### Examples 145-151

Examples 145-151 are the same as Example 1 in the steps of the process for preparing a secondary battery, except that the content of the additive in the electrolyte is different. See Table 8 for details.

TABLE 8
Comparison of Performance of Batteries
with Different Amounts of Additives

| | | | Electrochemical Performance | |
|---|---|---|---|---|
| | Content of | | Number of times of cycles | Energy |
| | the Additive in | | (times) when the capacity | Density |
| No. | the electrolyte | | decays to 90% | (Wh/kg) |
| Example 145 | 0.1 | wt % | 50 | 300 |
| Example 146 | 1 | wt % | 120 | 250 |
| Example 147 | 2 | wt % | 200 | 255 |
| Example 148 | 3 | wt % | 220 | 263 |
| Example 149 | 5 | wt % | 250 | 263 |
| Example 1 | 10 | wt % | 180 | 263 |
| Example 150 | 15 | wt % | 100 | 255 |
| Example 151 | 20 | wt % | 50 | 250 |

As can be seen from Table 8, the cycle stability of the battery is best when the content of the additive is 5 wt %.

### Examples 152-153

Examples 152-153 are the same as Example 1 in the steps of the process for preparing a secondary battery, except that the type of the separator is different. See Table 9 for details.

TABLE 9
Comparison of Performance of Batteries with Different Separators

| | | Electrochemical Performance | |
|---|---|---|---|
| | | Number of times of cycles | Energy |
| | | (times) when the capacity | Density |
| No. | Separator | decays to 90% | (Wh/kg) |
| Example 1 | glass fiber paper | 250 | 263 |
| Example 152 | porous polymer | 250 | 263 |
| | separator | | |
| Example 153 | inorganic porous | 250 | 263 |
| | film | | |

It can be seen from Table 9 that the conventional separators can be selected and used as the separator, all of which enable the secondary battery of the present disclosure to obtain better cycle performance and higher energy density.

### Examples 154-159

Examples 154-159 are the same as Example 1 in the steps of the process for preparing a secondary battery, except that the active material, the conductive agent, and the binder in the positive electrode material are different in type and percentage by weight. See Table 10 for details.

TABLE 10
Comparison of Performance of Batteries with Different Amounts
of Positive Active Materials, Conductive Agents, and Binders

| | | | | Electrochemical Performance | |
|---|---|---|---|---|---|
| | | | | Number of times | |
| | Positive Electrode Material | | | of cycles (times) | Energy |
| | Active Material | Conductive Agent | Binder | when the capacity | Density |
| No. | (percentage by weight) | (percentage by weight) | (percentage by weight) | decays to 90% | (Wh/kg) |
| Example 1 | lithium cobalt oxide | acetylene black | polyvinylidene fluoride | 250 | 263 |
| | (80%) | (10%) | (10%) | | |
| Example 154 | lithium cobalt oxide | conductive carbon spheres | polytetrafluoroethylene | 220 | 250 |
| | (90%) | (0.1%) | (9.9%) | | |
| Example 155 | lithium cobalt oxide | conductive graphite | polyvinyl alcohol | 220 | 250 |
| | (60%) | (30%) | (10%) | | |
| Example 156 | lithium cobalt oxide | carbon nanotube | polypropylene | 180 | 250 |
| | (90%) | (9.9%) | (0.1%) | | |
| Example 157 | lithium cobalt oxide | graphene (5%) | carboxymethyl cellulose + | 200 | 260 |
| | (90%) | | SBR (5%) | | |
| Example 158 | lithium cobalt oxide | conductive carbon fiber | polyvinylidene fluoride | 200 | 260 |
| | (90%) | (5%) | (5%) | | |
| Example 159 | lithium cobalt oxide | acetylene black + carbon | polyvinylidene fluoride | 200 | 260 |
| | (90%) | nanotube (5%) | (5%) | | |

### Examples 160-172

Examples 160-172 are the same as Example 1 in the steps of the process for preparing a secondary battery, except that the type of the positive current collector is different. See Table 11 for details.

TABLE 11
Comparison of Performance of Batteries with
Different Positive Current Collectors

| | | Electrochemical Performance | | |
|---|---|---|---|---|
| | | | Number of times | |
| | Positive | Specific | of cycles (times) | Energy |
| | current | Capacity | when the capacity | Density |
| No. | collector | (mAh/g) | decays to 90% | (Wh/kg) |
| Example 1 | aluminum foil | 170 | 250 | 263 |
| Example 160 | magnesium foil | 170 | 250 | 263 |
| Example 161 | lithium foil | 170 | 250 | 263 |
| Example 162 | vanadium foil | 170 | 250 | 263 |
| Example 163 | copper foil | 170 | 250 | 263 |
| Example 164 | iron foil | 170 | 250 | 263 |
| Example 165 | tin foil | 170 | 250 | 263 |
| Example 166 | zinc foil | 170 | 250 | 263 |
| Example 167 | nickel foil | 170 | 250 | 263 |
| Example 168 | titanium foil | 170 | 250 | 263 |
| Example 169 | manganese foil | 170 | 250 | 263 |
| Example 170 | copper-zinc | 170 | 250 | 263 |
| | alloy | | | |
| Example 171 | tin-iron alloy | 170 | 250 | 263 |
| Example 172 | nickel-zinc | 170 | 250 | 263 |
| | alloy | | | |

1. A secondary battery comprising a battery negative electrode, an electrolyte, a separator, and a battery positive electrode,
wherein the negative electrode of the battery comprises a negative current collector; the negative current collector comprises a metal or a metal alloy or a metal composite conductive material, and the negative current collector also acts as a negative active material;
the electrolyte comprises an electrolyte salt and a solvent, and the electrolyte salt is a lithium salt;
the positive electrode of the battery comprises a positive current collector and a positive active material layer, the positive active material layer comprises a positive active material capable of reversibly de-intercalating and intercalating lithium ions, and the positive current collector comprises a metal or a metal alloy or a metal composite conductive material.

2. The secondary battery according to claim 1, wherein the negative current collector includes any one of aluminum, magnesium, lithium, vanadium, copper, iron, tin, zinc, nickel, titanium, and manganese, or an alloy of any one thereof, or a composite of any one thereof.

3. The secondary battery according to claim 2, wherein a structure of the negative current collector is an aluminum foil, or a porous aluminum coated with a carbon material, or a multilayered composite material of aluminum.

4. The secondary battery according to claim 1, wherein the positive active material includes one or several selected from the group consisting of lithium cobalt oxide, lithium nickel oxide, lithium manganese oxide, lithium iron phosphate, lithium nickel cobalt oxide binary material, spinel-structured oxide, lithium nickel cobalt manganese oxide ternary material, and a layered lithium-rich high-manganese material, or a composite material of one selected from the group.

5. The secondary battery according to claim 1, wherein the positive current collector includes any one of aluminum, magnesium, lithium, vanadium, copper, iron, tin, zinc, nickel, titanium and manganese, or a composite of any one thereof, or an alloy of any one thereof.

6. The secondary battery according to claim 1, wherein the electrolyte salt includes one or several of lithium hexafluorophosphate, lithium perchlorate, lithium tetrafluoroborate, lithium acetate, lithium salicylate, lithium acetoacetate, lithium carbonate, lithium trifluoromethanesulfonate, lithium lauryl sulfate, lithium citrate, lithium bis(trimethylsilyl)amide, lithium hexafluoroarsenate, and lithium bis(trifluoromethanesulfonyl)imide, and has a concentration ranging from 0.1 to 10 mol/L.

7. The secondary battery according to claim 6, wherein the concentration of the electrolyte salt is 0.5 to 2 mol/L.

8. The secondary battery according to claim 6, wherein the electrolyte salt is lithium hexafluorophosphate at a concentration of 1 mol/L.

9. The secondary battery according to claim 1, wherein the solvent includes one or more of ester, sulfone, ether, and nitrile organic solvents, and ionic liquids.

10. The secondary battery according to claim 9, wherein the solvent includes one or more of propylene carbonate, ethylene carbonate, butylene carbonate, diethyl carbonate, dimethyl carbonate, dipropyl carbonate, ethyl methyl carbonate, methyl propyl carbonate, dibutyl carbonate, butyl methyl carbonate, methyl isopropyl carbonate, methyl ester, methyl formate, methyl acetate, N,N-dimethylacetamide, fluoroethylene carbonate, methyl propionate, ethyl propionate, ethyl acetate, γ-butyrolactone, tetrahydrofuran, 2-methyltetrahydrofuran, 1,3-dioxolane, 4-methyl-1,3-dioxolane, dimethoxymethane, 1,2-dimethoxyethane, 1,2-dimethoxy propane, triethylene glycol dimethyl ether, dimethyl sulfone, dimethyl ether, ethylene sulfite, propylene sulfite, dimethyl sulfite, diethyl sulfite, and crown ether.

11. The secondary battery according to claim 10, wherein the solvent is ethylene carbonate, ethyl methyl carbonate and dimethyl carbonate in a volume ratio of 1:1:1, or ethylene carbonate and dimethyl carbonate in a volume ratio of 1:1, or ethylene carbonate and ethyl methyl carbonate in a volume ratio of 1:1.

12. The secondary battery according to claim 1, wherein the electrolyte further comprises an additive, and the additive includes one or several of ester, sulfone, ether, nitrile or alkene organic additives.

13. The secondary battery according to claim 12, wherein the additive includes one or more of fluoroethylene carbonate, vinylene carbonate, vinyl ethylene carbonate, 1,3-propanesultone, 1,4-butanesultone, ethylene sulfate, propylene sulfate, vinylene sulfate, ethylene sulfite, propylene sulfite, dimethylsulfite, diethylsulfite, vinylene sulfite, methyl chloroformate, dimethyl sulfoxide, anisole, acetamide, diazine, pyrimidine, crown ether/12-crown-4, crown ether/18-crown-6, 4-fluoroanisole, fluorinated noncyclic ether, difluoromethyl ethylene carbonate, trifluoromethyl ethylene carbonate, chloroethylene carbonate, bromoethylene carbonate, trifluoromethyl phosphonic acid, bromobutyrolactone, ethyl fluoroacetate, phosphate, phosphite, phosphazene, ethanolamine, carbodiimide, cyclobutyl sulfone, 1,3-dioxolane, acetonitrile, long-chain alkene, aluminum oxide, magnesium oxide, barium oxide, sodium carbonate, calcium carbonate, carbon dioxide, sulfur dioxide, and lithium carbonate.

14. The secondary battery according to claim 12, wherein in the electrolyte, the content of the additive is 0.1 to 20 wt % by weight.

15. The secondary battery according to claim 13, wherein in the electrolyte, the additive is vinylene carbonate and the content of the additive is 1 to 5 wt % by weight.

16. The secondary battery according to claim 13, wherein in the electrolyte, the additive is ethylene sulfite, propylene sulfite, or vinylene sulfite, and the content of the additive is 1 to 5 wt % by weight.

17. The secondary battery according to claim 1, wherein the positive active material layer further comprises a conductive agent and a binder, the content of the positive active material is 60 to 95 wt %, the content of the conductive agent is 0.1 to 30 wt %, and the content of the binder is 0.1 to 10 wt %.

18. The secondary battery according to claim 1, wherein the separator is an insulating porous polymer film or inorganic porous film, including one or more of a porous polypropylene film, a porous polyethylene film, a porous composite polymer film, a glass fiber-based film, and a porous ceramic separator.

19. A method for preparing a secondary battery, comprising steps of:
preparing a negative electrode, wherein a metal or a metal alloy or a metal composite conductive material is cut to be in a desired size, washed clean, and then used as a negative electrode, the metal or the metal alloy or the metal composite conductive material acting as both a negative current collector and a negative active material simultaneously;
preparing an electrolyte, wherein a certain amount of a lithium salt is weighed and added to a corresponding solvent, fully stirred and dissolved to obtain an electrolyte;
preparing a separator, wherein a porous polymer film, an inorganic porous film or a glass fiber film is cut to be in a desired size and washed clean;
preparing a battery positive electrode, wherein a positive active material, a conductive agent and a binder are weighed in a certain ratio, added to a suitable solvent and sufficiently grinded into a uniform slurry; a metal or a metal alloy or a metal composite conductive material, after a surface thereof is washed clean, is used as a positive current collector; and then the slurry is uniformly applied to a surface of the positive current collector, and after the slurry is completely dried to form a positive active material layer, the positive current collector with the positive active material layer is cut to provide a battery positive electrode with a desired size; and
assembling the battery negative electrode, the electrolyte, the separator, and the battery positive electrode sequentially to provide a secondary battery.
